(19) United States
(12) Patent Application Publication
(10) Pub. No.: US 2005/0160018 A1
(43) Pub. Date: Jul. 21, 2005

(54) Method for supplying cd insurance clauses

(76) Inventor: Yong Jong Choi, Yangcheon-ku, Seoul (RU)

Correspondence Address: JORDAN AND HAMBURG LLP, 122 EAST 42ND STREET, SUITE 4000, NEW YORK, NY, 10168, US

(21) Appl. No.: 10/504,732

(22) PCT Filed: Feb. 14, 2003
(86) PCT No.: PCT/KR03/00308

(30) Foreign Application Priority Data
Feb. 16, 2002 (KR) 10-2002-0008347

(51) Int. Cl. G06F 17/60

(52) U.S. Cl. 705/35

(57) ABSTRACT

Disclose herein is a method for supplying CD insurance clauses, which provides the CD-stores insurance clause, in which a corresponding insurance clause and an insurance clause previously made are stored in a CD, provided to an insured party at the time of making a contract. The method includes the steps of storing insurance clauses provided by insurance companies on an insurance database of a clause provision web server; storing related insurance company, each of kinds of insurance of each insurance company, each of main insurances of each insurance company and each of composite insurances of each insurance company, and enabling each insurance company to provide the related insurance clauses to an insured party; ad an insured party accessing the clause provision web server and searching the insurance database to read his insurance clauses.

### TECHNICAL FIELD

The present invention relates, in general, to a method for supplying an insurance clauses that is supplied to an insured party at the time of making a contract for one of various kinds of insurances, and, more particularly, to a method for supplying CD insurance clauses, which provides the compact disc-stored insurance clauses in which a corresponding insurance clauses, or the corresponding insurance clauses as well as an insured party's insurance clauses previously made with a corresponding insurance company or another insurance company are stored on a compact disc, at the time of making a contract for a corresponding insurance, and which enables the compact disc-stored insurance clauses to be read through the Internet.

### BACKGROUND ART

In general, an insurance company is obligated to provide the conditions of insurance clauses to an insured party. Hitherto, insurance clauses have been provided to an insured party after being printed on printing paper. The insurance clauses includes conditions, such as the explanation of the terms of the insurance clauses, the construction of the insurance and examples of insurance payment, the validity of a contract for an insurance, the payment procedure of an insurance payment and so on.

Meanwhile, each insurance company has developed and sold ten to thirty kinds of insurances. Each insurance company previously prints insurance clauses corresponding to the amount of insurances to be sold for one to three months with respect to each of the kinds of insurances and then provides the insurance clauses. Particularly, each insurance company manufactures printed insurance clauses, which are little sold, corresponding to the amount of insurances to be sold for about three months, because their manufacturing cost is high.

As a contract for an insurance become more complicated, an insurance clause can reach two to three hundred pages, so that the manufacturing cost of the insurance clause is increased and searches for desired clauses of the insurance clause are very inconvenient.

Recently, with the spread of personal computers and the development of the Internet, each insurance company manages websites and provides services for clients to read insurance clauses being sold, but the insurance company provides services for publicizing the insurance clause, differently from the discharging of an obligation to provide the insurance clause.

Hitherto, if an insurer makes contracts for a plurality of insurances, the insurer is inconvenienced in that he provides an individual insurance clause with respect to each of the insurances. Additionally, in the case where a clause is not sold any more or changed, remaining insurance clauses come into disuse, so that the undesirable waste of sources is incurred. Additionally, in the case where the number of manufactured insurance clauses is small due to underestimation of the expected amount of insurances to be sold, printed insurance clauses are not provided at a suitable time. Additionally, the classification, storage and supply of printed insurance clauses consume much space and labor according to the kinds of insurances. Additionally, since insurance clauses not being sold are not stored but disused, the conventional scheme is problematic in that the clauses cannot be provided to existing insured parties even though they request the clauses.

Additionally, the terms of an insurance clause tend to be ignored rather than read and understood by an insured party due to the limits of printing paper on which the terms of the insurance clause are recorded in difficult legal terminology, so that the insurance clause may not be properly be used by the insured party.

### DISCLOSURE OF THE INVENTION

Accordingly, the present invention has been made keeping in mind the above problems occurring in the prior art, and an object of the present invention is to provide a method for supplying a Compact Disc (CD)-stored insurance clause, which stores a corresponding insurance clause on a CD and provides the corresponding insurance clause stored on the CD at the time of making a contract for a corresponding insurance, and, more particularly, to a method for supplying CD insurance clause, which provides the CD-stored insurance clause in which existing insurance clauses as well as the corresponding insurance clause are stored on a CD, and which enables the CD-stored insurance clause to be read through the Internet, in the case where an insured party has the insurance clause previously made with a corresponding insurance company or another insurance company, thereby allowing the inured party to conveniently store and confirm clauses of all insurances for which the insured party has been insured, through the CD-stored insurance clause and the Internet.

In order to accomplish the above object, the present invention provides a method for supplying CD insurance clauses, including the steps of: storing insurance clauses provided by insurance companies having made an clause with an clause provision web server on an insurance database of the clause provision web server; storing related insurance clauses on a CD with respect to each of insurance clauses of each insurance company, each of kinds of insurances of each insurance company, each of main insurances of each insurance company and each of composite insurances of each insurance company, and enabling each insurance company to provide the related insurance clauses to an insured party; and an insured party accessing the clause provision web server through the Internet and searching the insurance database to read his or her own corresponding insurance clauses.

According to another embodiment of the present invention, the method for supplying CD insurance clauses includes the steps of: the clause provision web server constructing an insured party database at the time of constructing the insurance database; determining whether a new insured party has been previously insured for another insurance when manufacture of a CD-stored insurance clause is requested through input of personal information of the new insured party from an insurance company terminal, and storing another insurance clause along with a corresponding new insurance clause on a CD to provide it to the insured party if the insured party has been previously insured for another insurance; and the clause provision web server searching for insurance clauses and kinds of corresponding insurances, for which the insured party having personal information has been insured, in the insurance database and the insured party database, respectively, and outputting the insurance clauses and kinds of the corresponding insurances to allow the insured party to read them when the insured party accesses the clause provision web server through the Internet and inputs the personal information.

According to a further embodiment of the present invention, the method for supplying insurance clause further includes the step of separately constructing a clause database of insurances not being sold in the insurance database, and providing clauses of the insurances not being sold along with clauses of insurances being sold.

### BRIEF DESCRIPTION OF THE DRAWINGS

FIG. 1 is a flowchart illustrating a method for supplying an insurance clause, clauses of main insurances or clauses of all insurances being sold, which are stored on a single CD;

FIG. 2 is a flowchart illustrating a method for supplying a new CD-stored insurance clause in which existing insurance clauses are included at the time of providing the new CD-stored insurance clause; and

FIG. 3 is a flowchart illustrating a method for supplying a new CD-stored insurance clause in which insurance clauses made with a corresponding new insurance company and previously made with another company are included at the time of providing the new CD-stored insurance clause.

### BEST MODE FOR CARRYING OUT THE INVENTION

Hereinafter, a construction and an operation according to the present invention are described with reference to the accompanying drawings.

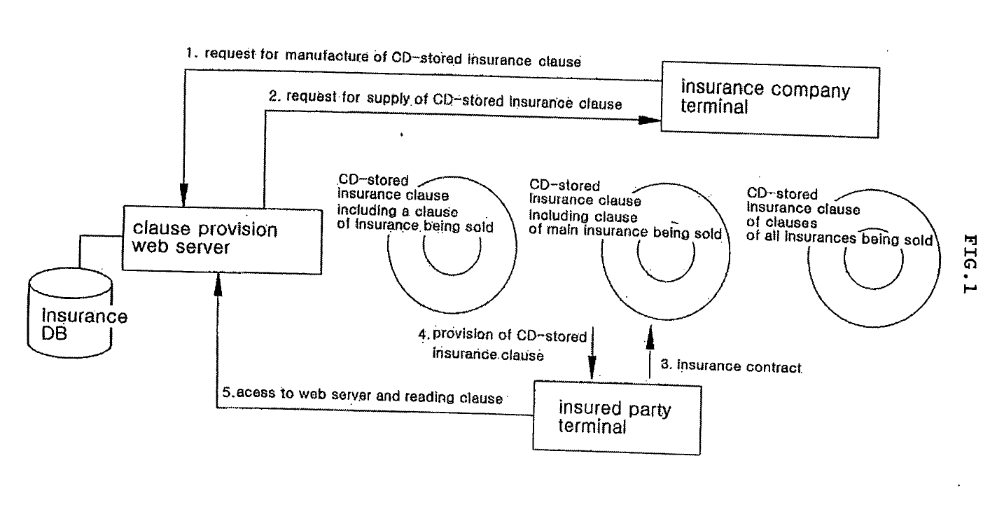

FIG. 1 is a flowchart illustrating a method for supplying an insurance clause, clauses of main insurances or clauses of all insurances being sold, which are stored on a single CD.

When an insurance company having made an agreement with an operator of a clause provision web server accesses the clause provision web server on-line or off-line and requests the manufacture of a CD-stored insurance clause from the clause provision web server, the operator of the clause provision web server stores a corresponding insurance clause on an insurance DataBase (DB), and manufactures a CD-stored insurance clause and supplies the CD-stored insurance clause to the insurance company. Such a CD-stored insurance clause is manufactured so that each of the clauses of insurances being sold is stored on an individual CD, the clauses of main insurances being sold are stored on one CD, or the clauses of all insurances being sold are stored on one CD. Accordingly, a CD-stored insurance clause needed at the time of making a contract may be rapidly supplied to an insured party. Additionally, the CD-stored insurance clause is constructed to be output in a tree structure consisting of the kinds of insurances, tables of contents and texts. Additionally, the CD-stored insurance clause is constructed so that a corresponding text is automatically output in a voice form if the insured party selects one of the contents. Accordingly, the text of the insurance clause may be exactly understood by the people whose eyes feel tired, or visually handicapped persons, such as weak-eyed person or the like.

Meanwhile, if an insured party accesses the clause provision web server through the Internet and selects a new insurance for which the insured party is newly insured, a corresponding insurance clause is output from the insurance DB and transmitted to the insured party, so that the insured party can also read the clause through the Internet.

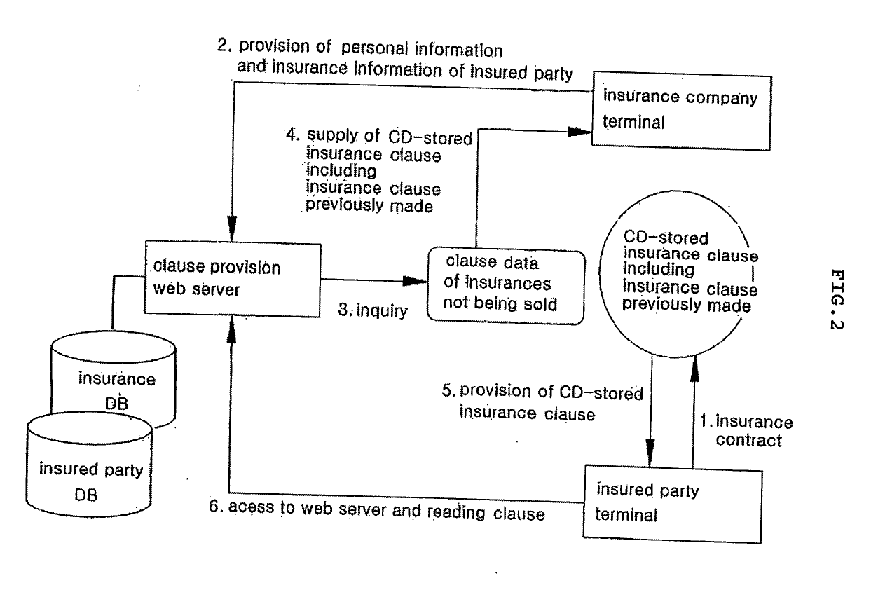

FIG. 2 is a flowchart illustrating a method for supplying a new CD insurance clause in which existing insurance clauses are included at the time of providing the new CD-stored insurance clause.

When an insurance contract is made between an insured party and insurance company having made an agreement with the operator of the clause provision web server, and the insurance company requests the manufacture of a CD-stored insurance clause from the clause provision web server, the insurance company provides the personal information and insurance information of the insured party to the clause provision web server. The clause provision web server constructs an insurance DB for storing clause information with respect to each of insurances and an insured party DB.

Thereafter, if the manufacture of the CD-stored insurance clause is requested through the input of the personal information of a new insured party from an insurance company terminal, it is determined whether the new insured party has been previously insured for another insurance through a search of the insured party DB. If the new insured party has been previously insured for another insurance, the CD-stored insurance clause in which a clause of another insurance along with a corresponding new insurance clause is stored on a CD, is provided to the insured party.

If such an insured party accesses the clause provision web server through the Internet and inputs his or her personal information, the clause provision web server searches for the insurance clause and kind of a corresponding insurance, for which the insured party having the personal information has been insured, in the insurance DB and the insured party DB, respectively, and outputs and transmits them so that the insured party can read them.

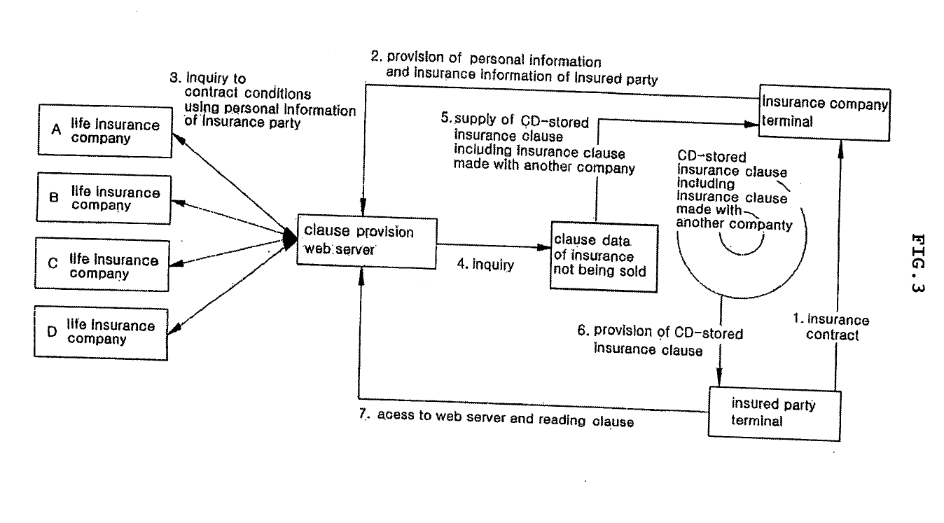

FIG. 3 is a flowchart illustrating a method for supplying a new CD insurance clause in which insurance clauses previously made with another company are included at the time of providing the new CD-stored insurance clause.

When an insurance contract is made between an insured party and an insurance company having made an clause with the operator of the clause provision web server, and the insurance company requests the manufacture of a CD-stored insurance clause from the clause provision web server, the insurance company provides the personal information and insurance information of the insured party to the clause provision web server.

The clause provision web server constructs an insurance DB for storing clause information with respect to insurances and an insured party DB, and insurance clauses are separately stored on the insurance DB with respect to each of insurance companies selling corresponding insurance. The reason for this is to separately store all insurance clauses previously made on one CD with respect to each of the insurance companies and provide the insurance clauses, in the case where a new insured party has an insurance clause previously made with another insurance company as well as another insurance clause previously made with a corresponding insurance company when a CD-stored insurance clause is provided to the new insured party.

Accordingly, if the manufacture of the CD-stored insurance clause is requested through the input of the personal information of a new insured party from an insurance company terminal, it is determined whether the new insured party has been previously insured for another insurance or has an insurance clause made with another company through a search for the insured party DB. If the new insured party has been previously insured for another insurance or has an insurance clause made with another company, the CD-stored insurance clause, in which an clause of another insurance or the insurance clause made with another company along with a corresponding new insurance clause is stored on a CD, is provided.

Additionally, if an insured party accesses the clause provision web server through the Internet and inputs his or her personal information, the clause provision web server searches for the insurance clauses and kinds of corresponding insurances, for which the insured party having the personal information has been insured, in the insurance DB and the insured party DB, respectively, and outputs the insurance clauses and kinds of the corresponding insurances. Thereafter, the insurance clauses and kinds of the corresponding insurances classified according to insurance companies are transmitted to the insured party to be read thereby. Accordingly, the insurance clauses of all insurances for which an insured party has been insured may be read by the insured party through the Internet regardless of the kinds of insurance companies.

Meanwhile, a clause DB for insurances not being sold is constructed in the insurance DB to be apart from the insurance DB of insurances being sold. Accordingly, in the case where an insured party has been previously insured for an insurance not being sold at the time of manufacturing a new insurance clause of a new insurance contract, the clauses of the insurances not being sold is included in a CD-stored insurance clause to be supplied.

### Industrial Applicability

As described above, according to the present invention, a CD-stored insurance clause, in which an insurance clause provided at the time of making a contract for a new insurance as well as an insurance clause previously made are stored on a single CD, is provided. Accordingly, insurance clauses are not previously manufactured, so that resources are saved and costs are reduced. In the case where an insurance is changed or is not sold any more, the amount of clauses of disused insurances is decreased. Additionally, an insurance policy, an insurance application design form, and a guide may be included in the CD, so that composite services may be provided.

1-3. (canceled)

4. A method of supplying computer-readable media having insurance clauses recorded thereon to an insured party, the method comprising:
constructing an insured party database together with an insurance database in a clause provision web server, in a state that the clause provision web server, an insured party terminal, and an insurance company terminal are connected to each other via the Internet;
determining whether a new insured party has had another type of insurance when insurance clauses of a new insurance plan are requested through input of personal information of the new insured party from the insurance company terminal, followed by recording the insurance clauses of the new insurance plan together with insurance clauses of the other type of insurance on the computer-readable media to be supplied to the new insured party if the new insured party has had the other type of insurance; and
retrieving the insurance clauses of the new insurance plan together with kinds of insurance, which the new insured party having the personal information has had, on the insured party database and the insurance database, followed by outputting the insurance clauses of the new insurance plan together with the kinds of insurance to allow the new insured party to read them when the new insured party accesses the clause provision web server through the Internet, and input the personal information.

5. The method according to claim 4, further comprising additionally constructing a databases for insurance plans, that are no longer offered, in the insurance database, thereby allowing the clauses for the insurance plans, that are no longer offered, to be supplied together with clauses of insurance plans being sold.
